(19) United States
(12) Patent Application Publication
(10) Pub. No.: US 2004/0059657 A1
(43) Pub. Date: Mar. 25, 2004

(54) Computerized systems and methods for performing transactions

(76) Inventors: Juergen Kind, Ostringen (DE); Georg Dopf, Schwetzingen (DE); Thomas Schachner, Sandhausen (DE)

Correspondence Address: Finnegan, Henderson, Farabow, Garrett & Dunner, L.L.P., 1300 I Street, N.W., Washington, DC, 20005-3315, US

(21) Appl. No.: 10/601,790

(22) Filed: Jun. 24, 2003

Related U.S. Application Data
(60) Provisional application No. 60/390,438, filed on Jun. 24, 2002.

(51) Int. Cl. G06F 17/60

(52) U.S. Cl. 705/35

(57) ABSTRACT

Computerized systems and methods are provided for performing transactions. In accordance with embodiments of the invention, a financial transaction tool may be implemented as a computer program with a plurality of modules that control a computer. The computer and program may cooperate with an application. A distributing module may receive a total amount and a calculation rule representation from the application to calculate a partial amount representation. Further, a posting module may receive the partial amount representation to provide a modifying instruction to a first table and a second table in a database.

### CROSS-REFERENCE TO RELATED APPLICATION

This application is related to and claims the benefit of priority under 35 U.S.C. 119(e) to U.S. Provisional Patent Application No. 60/390,438, filed on Jun. 24, 2002, the disclosure of which is expressly incorporated herein by reference in its entirety.

### BACKGROUND OF THE INVENTION

I. Field of the Invention

The present invention generally relates to the field of data processing and, more particularly, the invention relates to computer systems, programs, and methods that support transactions, such as financial transactions.

II. Background Information

Organizations like companies use computer systems that support a variety of applications. Such applications may include, for example, a finance application (Fl) or a human resource application (HR).

Applications for computer systems are commercially available. For example, “R/3” and “mySAP.com” are available from SAP Aktiengesellschaft, Walldorf (Baden), Germany.

Applications for computer systems may use software tools for predefined operations. Given the dynamic nature of today's software marketplace, flexibility of an application is highly appreciated.

For consideration, the following documents are useful: U.S. Pat. No. 6,044,138 (Graham et al.); U.S. Pat. No. 6,041,312 (Bickerton et al.); and U.S. Pat. No. 5,590,037 (Ryan at al.).

### SUMMARY OF THE INVENTION

According to embodiments of the invention, a computer program is provided that comprises a plurality of code modules that control a computer, the computer program cooperating with a computer application. The modules may comprise: a distributing module receiving a total amount and a calculation rule representation from the application to calculate a partial amount representation; and a posting module receiving the partial amount representation to provide a modifying instruction to a first table and to a second table in a database.

Optionally, the calculation rule representation may comprise contract information, the contract information including data such as time points, a sum value, and/or a history. In one embodiment, the partial amount representation represents an accrual value. In another embodiment, the distributing module receives the total amount and the calculation rule representation with the total amount at a first time point and with the calculation rule at a second time point.

In the computer program, the total amount and calculation rule representation may represent the total amount as a pointer to the database. Also, the computer program may be implemented as part of a data model or dictionary, such as a DDIC for a SAP R/3® system. Further, in one embodiment, the computer applications may comprise functions selected from the group of: leasing, stock option accounting, e-business accounting, financial services, customer relationship management, product lifecycle management, and media.

According to additional embodiments of the invention, a method is provided for controlling a computer to perform financial transactions, the method causing the computer to cooperate with a computer application. The method may comprise: receiving, with a distribution module, a total amount and a calculation rule representation from the computer application, and calculating a partial amount representation; and upon receiving the partial amount representation, providing with a posting module a modifying instruction to a first table and to a second table in a database.

The posting module may provide the modifying instruction to a database, wherein the database comprises a knowledge warehouse. Also, the distributing module may receive a further total amount and a calculation rule representation from a further application, wherein the further representation comprises an application identification rule.

In one embodiment, the distributing module and the posting module communicate with a computer application via first and/or second interfaces. Further, the distributing module may receive rule changes from the application via a user interface.

The modifying instructions may be provided to modify the first and second tables, wherein each of the tables are subdivided into credit and debit subtables. Additionally, the total amount and calculation rule representation may represent the total amount as a pointer to the database.

In accordance with still additional embodiments of the invention, a computer system is provided that comprises a plurality of program-implemented modules to cooperate with a computer application. The modules may comprise: a distributing module receiving a total amount and a calculation rule representation from the application to calculate a partial amount representation; and a posting module receiving the partial amount representation to provide a modifying instruction to a first table and to a second table in a database.

The data and calculation rule representation may comprise contract information. The contract information may comprise data selected from the group of: time points, sum value, and history. The partial amount representation may represent an accrual value. Further, the distributing module may receive the total amount and the calculation rule representation with the total amount at a first time point and with the calculation rule at a second time point.

In one embodiment, the posting module provides the modifying instruction to a database that is a knowledge warehouse. In another embodiment, the distributing module receives a further total amount and a calculation rule representation from a further application, wherein the further representation has an application identification rule. In yet another embodiment, the distributing module and the posting module communicate with both applications via first and/or second interfaces.

Optionally, the distributing module may be coupled to a user interface to changes rules that have been received from the application. Also, modifying instructions may be provided to modify first and second tables of a database, each of the tables being subdivided into credit and debit sub-tables.

It is to be understood that both the foregoing general description and the following detailed description are exemplary and explanatory only, and should not be considered restrictive of the scope of the invention, as described. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates a block diagram of an exemplary computer system for implementing embodiments of the invention;

FIG. 2 illustrates a diagram of an exemplary computer system operating under a computer program, consistent with embodiments of the present invention;

FIG. 3 illustrates an example of the operation of a distributing module in the computer program of FIG. 2;

FIG. 4 illustrates an example of the operation of a posting module in the computer program of FIG. 2;

FIG. 5 provides an exemplary overview about posting by illustrating a first table and a second table at consecutive time points;

FIG. 6 illustrates an exemplary flow chart diagram of a method of operation under control of a computer program, consistent with embodiments of the present invention;

FIG. 7 illustrates a more detailed block diagram of an exemplary computer program interacting with a calling application, consistent with embodiments of the present invention; and

FIG. 8 illustrates an overview about a plurality of further functions, consistent with embodiments of the invention.

### DETAILED DESCRIPTION

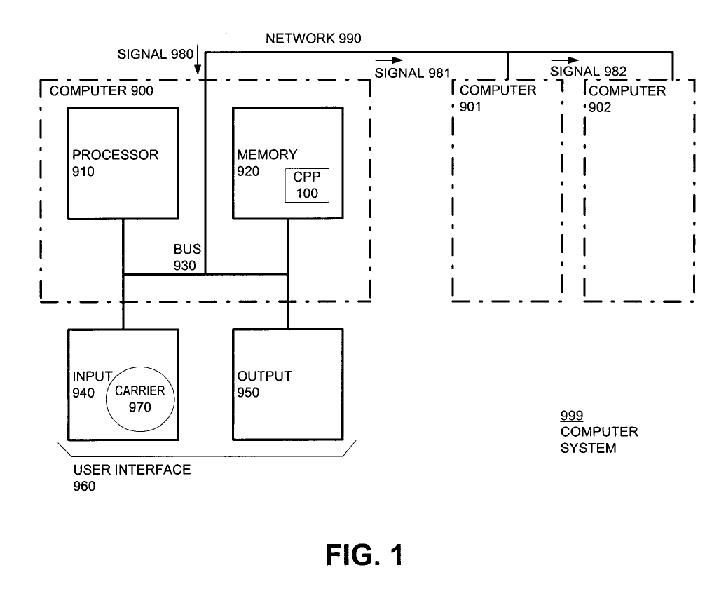

FIG. 1 illustrates a block diagram of an exemplary computer system 999 that may include a plurality of computers 900, 901 and/or 902 (or 90q, with q=0. . . Q−1, Q any number).

As shown in FIG. 1, computers 900-902 may be coupled via inter-computer network 990. Computer 900 comprises a processor 910, a memory 920, a bus 930, and, optionally, an input device 940 and an output device 950 (I/O devices, user interface 960 ). As illustrated, embodiments of the invention may be implemented through a computer program product 100 (CPP), a program carrier 970 and/or a program signal 980, collectively “program.”

With respect to computer 900, computer 901/902 may be referred to as a “remote computer.” Computer 901/902 is, for example, a server, a router, a peer device or other common network node, and typically comprises many or all of the elements described relative to computer 900. Hence, elements 100 and 910- 980 in computer 900 collectively illustrate also corresponding elements 1q and 91q-98 q(shown for q=0) in computers 90 q.

Computer 900 is, for example, a conventional personal computer (PC), a desktop, a hand-held device, a multiprocessor computer, a pen computer, a microprocessor-based or programmable consumer electronics device, a minicomputer, a mainframe computer, a personal mobile computing device, a mobile phone, a portable or stationary personal computer, a palmtop computer, or the like.

Processor 910 is, for example, a central processing unit (CPU), a micro-controller unit (MCU), a digital signal processor (DSP), or the like.

Memory 920 symbolizes elements that temporarily or permanently store data and instructions. Although memory 920 is conveniently illustrated as part of computer 900, memory function(s) can also be implemented in network 990, in computers 901/902 and processor 910 itself (e.g., cache, register), or elsewhere. Memory 920 may comprise a read only memory (ROM), a random access memory (RAM), and/or a memory with other access options. Memory 920 may be physically implemented by computer-readable media, such as, for example: (a) magnetic media, like a hard disk, a floppy disk or other magnetic disk, a tape, or a cassette tape; (b) optical media, like optical disks (CD-ROM, digital versatile disk—DVD); (c) semiconductor media, like DRAM, SRAM, EPROM, EEPROM, or memory sticks; or (d) by any other media, like paper.

Optionally, memory 920 is distributed across different media. Portions of memory 920 can be removable or non-removable. For reading from media and for writing in media, computer 900 uses devices well known in the art such as, for example, disk drives or tape drives.

Memory 920 stores support modules such as, for example, a basic input output system (BIOS), an operating system (OS), a program library, a compiler, an interpreter, and a text-processing tool. Such support modules may be implemented with commercially available modules and can be installed on computer 900, as can be appreciated by those skilled in the art. For simplicity, these modules are not illustrated.

CPP 100 comprises program instructions and, optionally, data that cause processor 910 to execute the methods of embodiments of the present invention. Exemplary methods are explained with more detail below. In other words, CPP 100 defines the operation of computer 900 and its interaction in network system 999. For example and without the intention to be limiting, CPP 100 can be available as source code in any programming language, or as object code (“binary code”) in a compiled form. Persons of skill in the art can use CPP 100 in connection with any of the above-mentioned support modules (e.g., compiler, interpreter, operating system).

Although CPP 100 is illustrated as being stored in memory 920, CPP 100 can be located elsewhere. CPP 100 can also be embodied in a carrier 970.

Carrier 970 is illustrated outside computer 900. For communicating CPP 100 to computer 900, carrier 970 may be conveniently inserted into input device 940. Carrier 970 may be implemented as any computer readable medium, such as any of the medium largely explained above (cf. memory 920 ). Generally, carrier 970 is an article of manufacture comprising a computer readable medium having computer readable program code means embodied therein for executing the methods of embodiments of the present invention. Further, program signal 980 can also embody computer program 100 and travel on network 990 to computer 900.

Having described CPP 100, program carrier 970, and program signal 980 in connection with computer 900 is convenient. Optionally, program carrier 971/972 (not shown) and program signal 981/982 embody computer program product (CPP) 101/102 that is executed by processor 911/912 (not shown) in computers 901/902, respectively.

Input device 940 symbolizes a device that provides data and instructions for processing by computer 900. For example, device 940 is a keyboard, a pointing device (e.g., a mouse, a trackball, cursor direction keys), a microphone, a joystick, a game pad, a scanner, or a disk drive. Although the examples are devices with human interaction, device 940 can also operate without human interaction, such as, a wireless receiver (e.g., with a satellite dish or a terrestrial antenna), a sensor (e.g., a thermometer), and/or a counter (e.g., a goods counter in a factory). Input device 940 can serve to read carrier 970.

Output device 950 symbolizes a device that presents instructions and data that have been processed. For example, a monitor or a display, (cathode ray tube (CRT), a flat panel display, a liquid crystal display (LCD), a speaker, a printer, a plotter, and/or a vibration alert device. Similar as above, output device 950 communicates with the user, but it can also communicate with further computers.

Input device 940 and output device 950 can be combined into a single device. Further, either device 940 or device 950 can be provided optionally.

Bus 930 and network 990 provide logical and physical connections by conveying instruction and data signals. While connections inside computer 900 are conveniently referred to as “bus 930,” connections between computers 900 -902 are referred to as “network 990.” Optionally, network 990 comprises gateways being computers that specialize in data transmission and protocol conversion.

Devices 940 and 950 are coupled to computer 900 by bus 930 (as illustrated) or by network 990 (optional). While the signals inside computer 900 are mostly electrical signals, the signals in network may be electrical, magnetic, optical and/or wireless (radio) signals.

Networking environments (such as network 990) are commonplace in offices, enterprise-wide computer networks, intranets and the Internet (i.e., the World Wide Web). The physical distance between a remote computer and computer 900 is not important. Network 990 can comprise a wired or a wireless network. To name a few network implementations, network 990 is, for example, a local area network (LAN), a wide area network (WAN), a public switched telephone network (PSTN), an Integrated Services Digital Network (ISDN), an infra-red (IR) link, a radio link, like Universal Mobile Telecommunications System (UMTS), Global System for Mobile Communication (GSM), Code Division Multiple Access (CDMA), or a satellite link.

Transmission protocols and data formats are known, such as transmission control protocol/Internet protocol (TCP/IP), hyper text transfer protocol (HTTP), secure HTTP, wireless application protocol (WAP), unique resource locator (URL), unique resource identifier (URI), hyper text markup language (HTML), extensible markup language (XML), extensible hyper text markup language (XHTML), wireless application markup language (WML), Standard Generalized Markup Language (SGML), etc.

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card.

Computers and programs are closely related. As used hereinafter, phrases such as “the computer provides” and “the program provides,” are convenient abbreviations to express actions by a computer that are controlled by a program.

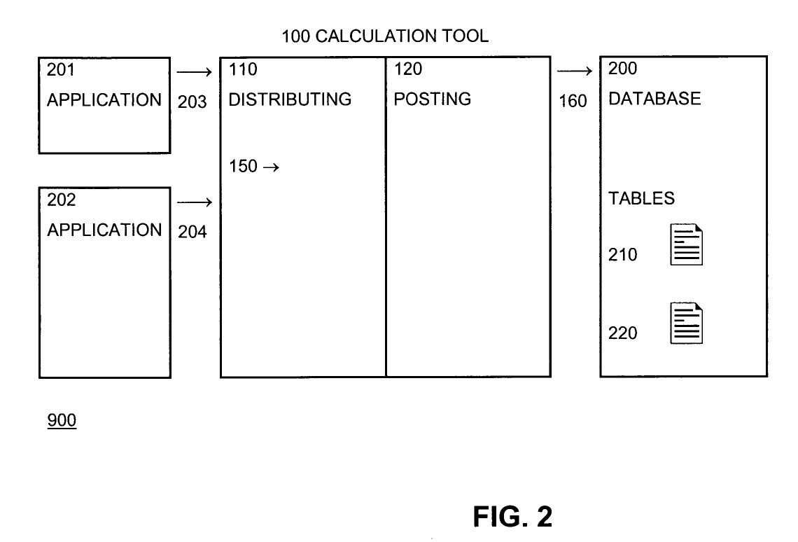

FIG. 2 illustrates a block diagram of an exemplary computer 900 operating under computer program 100 (i.e., a “calculation tool”), consistent with embodiments of the present invention. Computer 900 (or any computer in a system) further runs database 200, as well as application 201 and, optionally, application 202.

For convenience of explanation, calculation tool 100 (such as an “accrual engine”) is illustrated with two functional modules: a distributing module 110 and a posting module 120. Distributing module 110 may cooperate with application 201/202 to calculate a partial amount (PaA). Posting module 120 may cooperate with database 200 to actually transfer the partial amount (PaA) to tables 210 and 220 of database 200 (e.g., by periodic posting). More details concerning the operation of the modules is provided below.

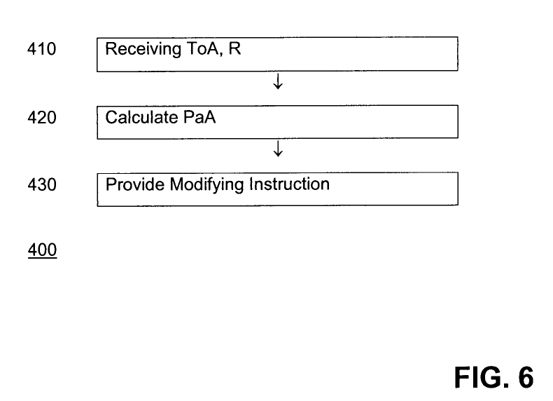

Distributing module 110 receives (cf. step 410 in FIG. 6) a total amount (ToA) and a calculation rule (R) representation (cf. representation 203 in FIG. 2) from application 201 and calculates (cf. step 420) a partial mount (PaA) representation (cf. representation 150 in FIG. 2).

Optionally and likewise, distributing module 110 may receive input (cf. representation 204) from application 202. Looking from a client-server viewpoint, calculation tool 100 may act like a server for a plurality of client applications 201 and 202.

Applications 201 and 202 themselves may include one or more components for special tasks, such as tasks related to insurance contracts, leasing contracts, bonds with fixed interest, subscriptions to publications (journals, newspapers) and the like.

Posting module 120 receives the calculated partial amount (PaA) representation 150 from distributing module 110 and provides (cf. step 430) a modifying instruction 160 to tables 210 and 220 in database 200. For example, instruction 160 may cause the partial amount (PaA) to be subtracted from table 210 and to be added to table 220.

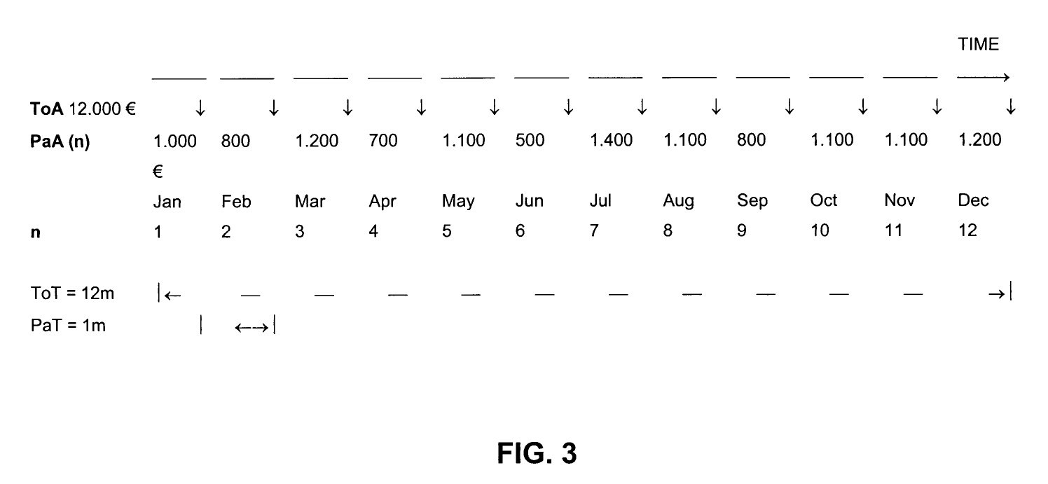

Distributing and posting events (i.e., sending representations 150, 160) may occur at predetermined time points. Exemplary details are explained in connections with FIGS. 3-5.

FIG. 3 illustrates an example of the operation of distributing module 110 in the embodiment of FIG. 2. In FIG. 3, acronyms are used as follows:

ToA Total amount to be distributed (ToA, e.g., 12.000 [symbol] ).

PaA(n) Partial amount to be posted at each time point, for example, at the end of each month (from January to December) and varying between 700 [symbol] and 1.400 [symbol] .

PaT Partial time being the time interval between consecutive posting events, for example, one month.

ToT Total time, conveniently given in time units (e.g., week, month), or given by calendar dates (e.g., from Jan. 01, 2002 to Dec. 31, 2002), for example, the duration of a financial contract.

n Index for posting events, for example, from 1 to 12 in each month.

The acronym “To” stands for “total”; the acronym “Pa” stands for “partial”; the acronym “A” stands for amount; and the acronym “T” stands for “time.”

Consistent with embodiments of the invention, ToA, PaA, ToT, and ToA may be related by rules. For example, the following calculation rules (R) may be provided:

R1 PaA(n)=800 . . . 1.400 [symbol] (as illustrated) for unequal distribution, wherein PaA depends on further predetermined criteria (such as the availability of money in the present month).

R2 Sum of N partial amounts PaA(n) equals ToA.

R3 PaA(n)=ToA/N in case of an equal distribution.

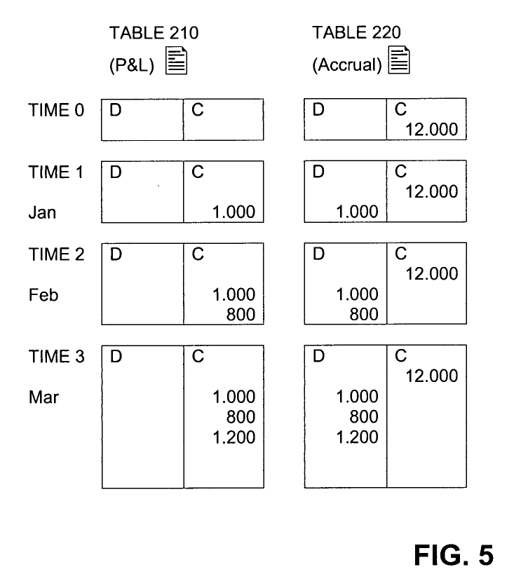

R4 Identification of Tables (cf. 210, 220 in FIG. 2), optionally with identification of portions in the tables (such as the columns debit D and credit C, cf. FIG. 5).

R5 Identification of application 201.

It is sufficient to indicate only some rules, for example, indicate R1 and R2. Further, various rules can be defined as will be appreciated by those of skill in the art.

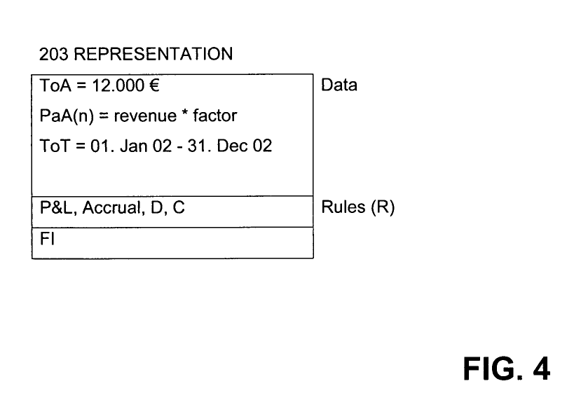

FIG. 4 illustrates an example of the operation of posting module 120 in the exemplary embodiment of FIG. 2. FIG. 4 illustrates that distributing module 110 may receive representation 203 from application 201 with the following exemplary content:

| | |
|---|---|
| ToA | 12.000 [symbol] |
| ToT | Jan to Dec |
| R1 | PaA (n) = revenue * factor |
| R2 | sum rule |
| R4 | P&L, Accrual, D, C |
| R5 | Fl (i.e., application is Fl) |

The distinction between “data” and “rule” is convenient, but not required. With this information, distributing module 110 may periodically (i.e., monthly) calculate PaA(n) and forward PaA(n) as output (cf. representation 150) to posting module 120. When required, module 110 also includes further information, such as ToA.

FIG. 5 provides an exemplary overview about posting by illustrating first table 210 and second table 220 at consecutive time points TIME 0, TIME 1 (end of January), TIME 2 (end of February), and TIME 3 (end of March). The example follows FIGS. 3-4.

At TIME 0, posting module 120 provides modifying instruction 160 (step 430 in FIG. 6) that causes database 200 to write ToA into column C of table 220 (“Accrual”).

At TIME 1 (end of January), posting module 130 provides modifying instruction 160 (step 430) that causes database 200 to write PaA(1) =1.000 [symbol] into column C of table 210 (“P&L”), as well as into column D of table (“Accrual”).

At TIME 2 (end of February), posting module 130 provides modifying instruction 160 (step 430) that causes database 200 to write PaA(2) =800 [symbol] into column C of table 210 (called “P&L”), as well as into column D of table (called “Accrual”).

At TIME 3 (end of March), posting module 120 provides modifying instruction 160 (step 430) that causes database 200 to write PaA(3)=1.200 [symbol] into column C of table 210 (“P&L”), as well as into column D of table (“Accrual”).

FIG. 6 illustrates an exemplary flow chart diagram of method 400 under control of computer program 100. Method 400 may be implemented for controlling computer 900 to perform financial transactions and for causing computer 900 to cooperate with computer application 201. The method steps 410-430 of FIG. 6 are described below.

As part of step 410, distributing module 110 receives total amount ToA and calculation rule R representation (cf. representation 203 in FIG. 2) from application 201. At step 420, partial amount PaA is calculated and partial amount PaA representation (cf. representation 150 in FIG. 2) is provided to posting module 120.

Upon receiving partial amount PaA representation, posting module 120 provides at step 430 modifying instruction 160 to first table 210 and second table 220 in database 200.

For applications in the finance area, the term “posting” refers to transferring an entry from a book of original entry (e.g., table 210) to the proper account in a ledger (e.g., an entry in table 220).

The following exemplary features and embodiments of the invention may be applied to method 400, program 100, and any computer 900 (or system, cf. FIG. 1) that performs the steps by program 100.

Data and calculation rule (cf. representation 203 in FIG. 2) may comprise contract information (cf. ToT, PaT, ToA or the like), such as time points, sum values, and historical data.

Preferably, partial amount PaA representation (cf. representation 150 in FIG. 2) represents an accrual value (i.e., values relating to accounting that recognizes income when earned and expenses when incurred regardless of when cash is received or disbursed).

Preferably, distributing module 110 receives (step 410 in FIG. 6) total amount ToA and calculation rule R representation (cf. representation 203) with total amount ToA at a first time point and with calculation rule R at a second time point. Receiving calculation rule R at the second time point triggers calculating (step 420 in FIG. 6).

Preferably, distributing module 110 and posting module 120 are each provided twice to simultaneously calculate (step 420) based on different rules. The rules may include, for example, at least one of the rules defined according to Generally Accepted Accounting Principles (GAAP). Other examples include: Handelsgesetzbuch (HGB), which is a German commercial code; or International Accounting Standard (IAS). Standard rules are suitable as well, such as rules to calculate percentages or discounts.

Preferably, posting module 120 provides modifying instruction 160 to database 200, wherein the database 200 is implemented as a knowledge warehouse.

Preferably, distributing module 110 receives a further total amount ToA and calculation rule R representation (cf. representation 204 in FIG. 2) from further application 202. Further representation 204 may include an application identification rule R (e.g., the above-mentioned HR).

Distributing module 110 and posting module 120 may communicate with both applications 201, 202 via first and second interfaces.

Modifying instruction 160 may be provided (step 430) so as to cause prima nota booking (especially suitable for SAP R/3®).

Modifying instruction 160 may be provided (step 430) so as to modify first table 210 and second table 220, each being subdivided into sub-tables for credit C and for debit D.

Preferably, total amount ToA and calculation rule R (cf. representation 203) represent total amount ToA as a pointer to the database 200 or to any other memory.

Preferably, distributing module 110 is coupled to a user interface to change rules that have been received (step 410) from application 201. The user interface is preferably, a graphical user interface. In other words, both distributing module 110 and posting module 120 may be adapted to cooperate with a visual user interface, such that the interface remote-controls distributing module 110 and posting module 120.

Preferably, modules 110 and 120 are implemented as a data model or dictionary, such as a DDIC in computer software using the technology of SAP Aktiengesellschaft.

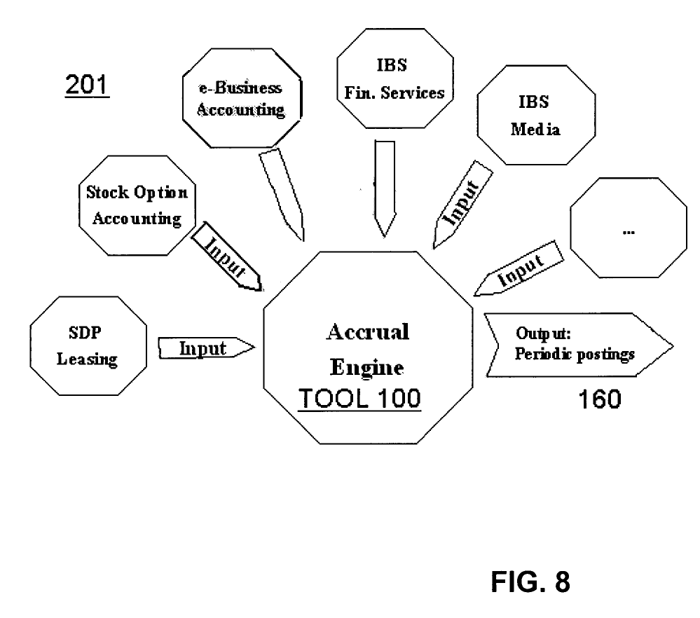

Applications 201, 202 may include one or more functions (cf. FIG. 8), such as leasing, stock option accounting (details below), e-business accounting, financial services, customer relationship management (CRM), media, and/or product lifecycle management (PLM).

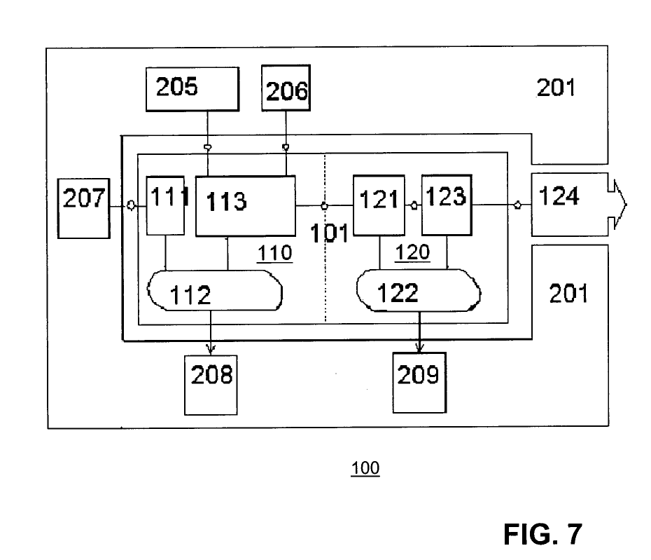

Preferably, modifying instruction 160 comprises reports (cf. FIG. 7). Also, distributing module 110 and posting module 120 (each alone or both) have a reporting function. In this regard, representations 203 may comprise global identification “GUID” to identify table entries.

Preferably, at least one of first and second tables 210, 220 comprises a ledger (i.e., a book containing accounts to which debits and credits are posted from books of original entry).

FIG. 7 illustrates a detailed block diagram of an exemplary computer program 100 interacting with a calling application 201 (illustrated as an O-shaped frame in the figure). In this embodiment, program 100 operates as an accrual engine. As explained above, program 100 may include distributing module 110 and posting module 120.

Application 201 has a function 205 that sends an accrual calculation trigger to module 110, a function 206 that sends an accrual rule identification to module 110, and a function 207 that transfers data to module 110 (in cooperation with a database). The communication of functions 205-207 to module 110 is part of representation 203. As illustrated in FIG. 7, application 201 also includes reporting functions 208 and 209 that receive reports from modules 110 and 120, respectively.

Distributing module 110 may include: a block 111 to create or change basis data (from function 207); a block 112 to store basis data (i.e., accrual objects -like financial contracts); and a block 113 to periodically calculate accruals (e.g., sending representation 150 to posting module 120).

Posting module 120 may include: a block 121 to provide a delta to already posted accrual values; a block 122 to temporarily store posted values (“accrual engine documents”, connected to reporting function 209); and a block 123 to post documents. As indicated by an arrow on the right of FIG. 7, module 120 may create accounting documents 124 as well (like invoices, monthly statements, etc.).

Block 112 comprises contract data that are identified by an identification of a component in calling application (e.g., component “ACAC” in application 201), a term of contract (e.g., Jan. 01, 2002 to Dec. 31, 2002), ToA (e.g., 5.000 Euro), or a contract reference to identify the contract (e.g., a string). It is possible to have further components (in application 201 or elsewhere) to interact with block 112. In this case, the contract data has further component identification (e.g., component “SOA” in application 201) and the contract reference is different.

Visual user interfaces allow a user to manually modify contract data. For example, a contract administrator can modify the contract term, or modify the amount. When opening the user interface, different menus may be presented depending on the application component (e.g., different headlines, different data to be modified).

A computer interface combination with first interface 201/203/110 and second interface 120/160/200 is summarized by the following means (i.e., implemented by program controlled computer).

The first interface has means for receiving (step 410) total amount ToA and calculation rule R representation (cf. representation 203) by distributing module 110 from computer application 201 to calculate (step 420) partial amount PaA representation (cf. representation 150).

The second interface has means to provide (step 430) modifying instruction 160 by posting module 120. Posting module 120 receives (step 420) partial amount PaA representation (cf. representation 150) from distributing module 110 and causes to modify first table 210 and second table 220 in database 200 by partial amount PaA).

Without going into well-known details of accounting, exemplary and simplified scenarios are provided with reference to (a) insurance and (b) stock option accounting.

(a) Insurance:

Required is interaction with finance application 201. A company (as the owner of program 100) is active in the insurance business and signs an insurance contract with a customer. The contract has a term of 12 months (ToT) and a value of 12.000 Euro (ToA). The company has liability to pay (12.000 Euro). The customer monthly pays 1.000 Euro (PaA) to the company. The company has several accounts (technically represented by tables). At the end of each month, it transfers 1.000 Euro to account A and to account B, each account standing for predetermined accounting functions.

(b) Stock Option Accountinq:

Required is interaction between finance application (Fl) 201 and a human resource application (HR) 202. A company has granted options to employees and needs to periodically transfer monetary entries from a first book to a second book. The company thereby accumulates money in the second book to serve options at any time point when employees exercise the options (i.e., buying company shares at predefined price).

There are many challenges and appropriate solutions. For example, share price might increase or decrease, or higher or lower partial amounts may be desired. Hence, calculation rules may need to be changed. Consistent with embodiments of the invention, the user interface allows a user to modify the rules. Thus, in the event that an employee leaves the company, his or her options can be invalidated and partial amounts concerning these options may no longer be considered. Such information should be transferred from the HR application (e.g., Fl application (e.g., 201).

Further implementations can be accomplished, for example, predefined mathematical operations in distributing module 110. For profit may be calculated for each time period as the difference between costs, such as 3000 Euro from 2000 Euro (income) minus 1000 Euro January to 2400 Euro (3600-1200) in December.

In a further example, a discount (e.g., 10 per cent) is calculated (a) to once in a table for a finance application (German standard) and (b) to be over the contract term (e.g., ToT of 12 months).

The rules (R) can be customized, for example, with the help of the user interface.

FIG. 8 illustrates an exemplary overview about a plurality of functions (e.g., in application 201) that may cooperate with program 100. As illustrated in FIG. 8 such functions may include: leasing, stock option accounting, e-business financial services, customer relationship management (CRM), media, and product lifecycle management (PLM).

Reference Numerals/Short Description

| | |
|---|---|
| 100 | computer program as calculating tool |
| 110 | distributing module |
| 111-113 | blocks in module 110 |
| 120 | posting module |
| 121-123 | blocks in module 120 |
| 150 | partial amount representation |
| 160 | modifying database instruction |
| 201 | application |
| 202 | application |
| 203 | calculation rule and data representation |
| | from application 201 |
| 204 | calculation rule and data representation |
| | from application 202 |
| 205-209 | functions in application 201 |
| 210 | first table |
| 220 | second table |
| 400, 4xx | method, steps |
| 9xx | computer and its components |

What is claimed:

1. A computer program comprising a plurality of code modules that control a computer, the computer program cooperating with a computer application, the modules comprising:
a distributing module receiving a total amount and a calculation rule representation from the application to calculate a partial amount representation; and
a posting module receiving the partial amount representation to provide a modifying instruction to a first table and to a second table in a database.

2. The computer program of claim 1, wherein the calculation rule representation comprises contract information.

3. The computer program of claim 2, wherein the contract information comprises data selected from the group of: time points, a sum value, and a history.

4. The computer program of claim 1, wherein the partial amount representation represents an accrual value.

5. The computer program of claim 1, wherein the distributing module receives the total amount and the calculation rule representation with the total amount at a first time point and with the calculation rule at a second time point.

6. The computer program of claim 5, wherein receiving the calculation rule at the second time point triggers a calculation.

7. The computer program of claim 1, wherein the distributing module and the posting module each are provided twice to simultaneously calculate based on different rules.

8. The computer program of claim 7, wherein at least one of the rules is defined in accordance with Generally Accepted Accounting Principles (GAAP).

9. The computer program of claim 8, wherein at least one of the rules is a standard rule, selected from the list of: a percentage, and a discount calculation.

10. The computer program of claim 1, wherein the posting module provides the modifying instruction to a database that is a knowledge warehouse.

11. The computer program of claim 1, wherein the distributing module receives a further total amount and a calculation rule representation from a further application, wherein the further representation has an application identification rule.

12. The computer program of claim 11, wherein the distributing module and the posting module communicate with both applications via first and second interfaces.

13. The computer program of claim 1, wherein the distributing module is coupled to a user interface to changes rules that have been received from the application.

14. The computer program of claim 1, wherein the modifying instruction is provided such to cause prima nota booking.

15. The computer program of claim 1, wherein modifying instructions are provided to modify the first and second tables, each of the tables being subdivided into credit and debit sub-tables.

16. The computer program of claim 1, wherein the total amount and the calculation rule representation represents the total amount as a pointer to the database.

17. The computer program of claim 1, wherein the computer program is implemented as a DDIC.

18. The computer program of claim 1, wherein at least one computer application is provided that comprises functions selected from the group of: leasing, stock option accounting, e-business accounting, financial services, customer relationship management, product lifecycle management, and media.

19. The computer program of claim 1, wherein the modifying instruction comprises reports.

20. The computer program of claim 1, wherein the representations comprise global identification to identify table entries.

21. The computer program of claim 1, wherein the distributing module and the posting module both include a reporting function.

22. The computer program of claim 1, wherein both the distributing module and the posting module cooperate with a visual user interface.

23. The computer program of claim 1, wherein a visual user interface is adapted to provide remote-control of the distributing module and the posting module.

24. The computer program of claim 1, wherein at least one of the first and second tables comprises a ledger.

25. A method for controlling a computer to perform financial transactions, the method causing the computer to cooperate with a computer application, the method comprising the following steps:
receiving, with a distributing module, a total amount and a calculation rule representation from the computer application, and calculating a partial amount representation; and
upon receiving the partial amount representation, providing with a posting module a modifying instruction to a first table and to a second table in a database.

26. The method of claim 25, wherein the calculation rule representation comprises contract information.

27. The method of claim 26, wherein the contract information comprises data selected from the group of: time points, a sum value, and a history.

28. The method of claim 25, wherein the partial amount representation represents an accrual value.

29. The method of claim 25, wherein the distributing module receives the total amount and the calculation rule representation with the total amount at a first time point and with the calculation rule at a second time point.

30. The method of claim 29, wherein receiving the calculation rule at the second time point triggers a calculation.

31. The method of claim 25, wherein the posting module provides the modifying instruction to a database, the database comprising a knowledge warehouse.

32. The method of claim 25, wherein the distributing module receives a further total amount and a calculation rule representation from a further application, wherein the further representation comprises an application identification rule

33. The method of claim 25, wherein the distributing module and the posting module communicate with a computer application via first and second interfaces.

34. The method of claim 25, wherein the distributing module receives rule changes from the application via a user interface.

35. The method of claim 25, wherein modifying instructions are provided to modify the first and second tables, each of the tables being subdivided into credit and debit sub-tables.

36. The method of claim 25, wherein the total amount and the calculation rule representation represent the total amount as a pointer to the database.

37. The method of claim 25, further comprising cooperating with at least one computer application with functions selected from the group of: leasing, stock option accounting, e-business accounting, financial services, customer relationship management, product lifecycle management, and media.

38. The method of claim 25, wherein providing the modifying instruction comprises providing reports.

39. A computer interface combination including a first interface and a second interface, the computer interface combination comprising:
in the first interface, means for receiving with a distributing module a total amount and a calculation rule representation from a computer application to calculate a partial amount representation; and
in the second interface, means to provide a modifying instruction with a posting module, wherein the posting module receives the partial amount representation from the distributing module and wherein the posting module causes a first table and a second table in a database to be modified by the partial amount.

40. A computer system comprising a plurality of program-implemented modules to cooperate with a computer application, the modules comprising:
a distributing module receiving a total amount and a calculation rule representation from the application to calculate a partial amount representation; and
a posting module receiving the partial amount representation to provide a modifying instruction to a first table and to a second table in a database.

41. The computer system of claim 40, wherein the calculation rule representation comprises contract information.

42. The computer system of claim 41, wherein the contract information comprises data selected from the group of: time points, a sum value, and a history.

43. The computer system of claim 40, wherein the partial amount representation represents an accrual value.

44. The computer system of claim 40, wherein the distributing module receives the total amount and the calculation rule representation with the total amount at a first time point and with the calculation rule at a second time point.

45. The computer system of claim 40, wherein the distributing module and the posting module each are provided twice to simultaneously calculate based on different calculation rules.

46. The computer system of claim 40, wherein at least one of the rules is a standard rule, selected from the list of: percentage and discount calculation.

47. The computer system of claim 40, wherein the posting module provides the modifying instruction to a database comprising a knowledge warehouse.

48. The computer system of claim 40, wherein the distributing module receives a further total amount and a calculation rule representation from a further application, wherein the further representation has an application identification rule.

49. The computer system of claim 48, wherein the distributing module and the posting module communicate with both applications via first and second interfaces.

50. The computer system of claim 40, wherein the distributing module is coupled to a user interface to changes rules that have been received from the application.

51. The computer system of claim 40, wherein modifying instructions are provided to modify the first and second tables, each of the tables being subdivided into credit and debit sub-tables.

52. The computer system of claim 40, wherein the total amount and the calculation rule representation represent the total amount as a pointer to the database.

53. The computer system of claim 40, wherein at least one computer application is provided that includes functions selected from the group of: leasing, stock option accounting, e-business accounting, financial services, customer relationship management, product lifecycle management, and media.
